(19) United States
(12) Patent Application Publication
(10) Pub. No.: US 2021/0138542 A1
(43) Pub. Date: May 13, 2021

(54) PHOTOSINTERING COMPOSITION AND METHOD OF FORMING CONDUCTIVE FILM USING THE SAME

(71) Applicant: NIPPON CHEMICAL INDUSTRIAL CO., LTD., Tokyo (JP)

(72) Inventors: Mari Tokutake, Tokyo (JP); Shinji Abe, Tokyo (JP)

(73) Assignee: NIPPON CHEMICAL INDUSTRIAL CO., LTD., Tokyo (JP)

(21) Appl. No.: 17/054,246

(22) PCT Filed: Apr. 17, 2019
(86) PCT No.: PCT/JP2019/016465

§ 371 Date: Nov. 10, 2020

(30) Foreign Application Priority Data
May 16, 2018 (JP) 2018-094610

(51) Int. Cl. B22F 3/10; B22F 9/02; B22F 7/00; H01B 1/22

(52) U.S. Cl. CPC B22F 3/1035; H01B 1/22; B22F 7/008; B22F 9/02

(57) ABSTRACT

Provided is a photosintering composition including: a cuprous oxide particle comprising at least one additive element selected from the group consisting of tin, manganese, vanadium, cerium, iron and silver; a metal particle having a volume resistivity at 20° C. of 1.0×10⁻³ ω·cm or less; and a solvent.

### TECHNICAL FIELD

The present invention relates to a photosintering composition and a method of forming a conductive film using the same.

### BACKGROUND ART

As a method of forming a conductive film on a substrate, a technique is known in which a dispersion of metal oxide particles is applied to a substrate to form a coating film and then the coating film is sintered by heating or photoirradiation (see, for example, Patent Literature 1). In particular, methods using photoirradiation are advantageous in that the coating film can be sintered at low temperature and the methods are therefore applicable to resin substrates with low heat resistance. As a cuprous oxide particle that can be used in such an application, Patent Literature 2, for example, discloses a cuprous oxide powder having an average primary particle size of 0.5 μm or less as measured by a scanning electron microscope and containing 30 ppm or more of iron, which is obtained by adding either of an alkaline solution or a copper ion-containing solution to which divalent iron ions have been added to the other to form copper hydroxide, and then adding a reducing agent to deposit cuprous oxide particles by reduction.

### CITATION LIST

### Patent Literature

Patent Literature 1: Japanese Patent Laid-Open No. 2014-71963
Patent Literature 2: Japanese Patent Laid-Open No. 2014-5188

### SUMMARY OF INVENTION

### Technical Problem

When the present inventors formed a coating film using a dispersion of the cuprous oxide powder described in Patent Literature 2 and performed a reduction treatment of the cuprous oxide powder by irradiating the coating film with light, it was found that a part of the coating film was scattered and thus an uneven conductive film was formed, and since reduction to copper and sintering was insufficient, a conductive film with low adhesion to a substrate was formed.

Thus, an object of the present invention is to provide a photosintering composition which can give a low-resistant, uniform conductive film having good adhesion to a substrate by photoirradiation, and a method of forming a conductive film using the same.

### Solution to Problem

The present inventors have conducted intensive studies in consideration of the above actual circumstances and, as a result, have found that a photosintering composition comprising a cuprous oxide particle containing a specific additive element, a metal particle having a specific volume resistivity and a solvent can solve the above problem, thereby completing the present invention.

Accordingly, the present invention provides a photosintering composition comprising a cuprous oxide particle comprising at least one additive element selected from the group consisting of tin, manganese, vanadium, cerium, iron and silver, a metal particle having a volume resistivity at 20° C. of 1.0×10⁻³ Ω·cm or less and a solvent.

The present invention also provides a method of forming a conductive film, comprising a step of applying the photosintering composition described above to a substrate to form a coating film and a step of irradiating the coating film with light to reduce cuprous oxide particles in the coating film.

### Advantageous Effects of Invention

The present invention can provide a photosintering composition which can give a low-resistant, uniform conductive film having good adhesion to a substrate by photoirradiation, and a method of forming a conductive film using the same.

### BRIEF DESCRIPTION OF DRAWINGS

FIG. 1 is an electron micrograph of the coating film formed in Example 1 (before photoirradiation) (10,000 magnifications).

FIG. 2 is an electron micrograph of the coating film formed in Example 1 (after photoirradiation) (10,000 magnifications).

FIG. 3 is an electron micrograph of the coating film formed in Comparative Example 1 (before photoirradiation) (10,000 magnifications).

FIG. 4 is an electron micrograph of the coating film formed in Comparative Example 1 (after photoirradiation) (10,000 magnifications).

### DESCRIPTION OF EMBODIMENTS

The photosintering composition of the present invention comprises a cuprous oxide particle comprising at least one additive element selected from the group consisting of tin, manganese, vanadium, cerium, iron and silver, a metal particle having a volume resistivity at 20° C. of 1.0×10⁻³ Ω·cm or less and a solvent.

The preferred content of the additive element in the cuprous oxide particle used in the present invention varies depending on the type of the additive element, and is usually in the range of 1 ppm to 30,000 ppm. When the additive element is tin, the content is preferably 1 ppm to 30,000 ppm, and more preferably 10 ppm to 10,000 ppm from the viewpoint of the solubility of tin ions and control of the particle size of cuprous oxide particles. When the additive element is manganese, the content is preferably 10 ppm to 20,000 ppm, and more preferably 30 ppm to 10,000 ppm from the viewpoint of the solubility of manganese ions and control of the particle size of cuprous oxide particles. When the additive element is vanadium, the content is preferably 10 ppm to 20,000 ppm, and more preferably 30 ppm to 10,000 ppm from the viewpoint of the solubility of vanadium ions and control of the particle size of cuprous oxide particles. When the additive element is cerium, the content is preferably 10 ppm to 30,000 ppm, and more preferably 30 ppm to 20,000 ppm from the viewpoint of the solubility of cerium ions and control of the particle size of cuprous oxide particles. When the additive element is iron, the content is preferably 1 ppm to 30,000 ppm, and more preferably 10 ppm to 10,000 ppm from the viewpoint of the solubility of iron ions and control of the particle size of cuprous oxide particles. When the additive element is silver, the content is preferably 1 ppm to 30,000 ppm, and more preferably 5 ppm to 20,000 ppm from the viewpoint of the solubility of silver ions and control of the particle size of cuprous oxide particles. Of these additive elements, tin is preferred because it has a low melting point and a low resistance. In the present invention, the content of the additive element in the cuprous oxide particles is measured by dissolving 1 g of cuprous oxide in 10 ml of concentrated hydrochloric acid and subjecting the solution to measurement by an ICP emission spectrometer (ICPS-8100 made by Shimadzu Corporation).

The average primary particle size of the cuprous oxide particles is preferably 1 nm to 1,000 nm, and more preferably 30 nm to 500 nm from the viewpoint of handleability and photosintering properties. The average primary particle size of the cuprous oxide particles may be adjusted based on conditions such as the concentration of ions to be added and the temperature at which a copper ion-containing aqueous solution and an alkaline solution are mixed in the production of cuprous oxide particles described later. The average primary particle size of the cuprous oxide particles according to the present invention means a value obtained by measuring the primary particle size of 50 cuprous oxide particles randomly selected in an image of cuprous oxide particles observed by a scanning electron microscope (SEM) and arithmetically averaging the values. Furthermore, the shape of the cuprous oxide particle is not particularly limited, and may be spherical, polyhedral or irregular.

The cuprous oxide particles may be produced by a method in which an aqueous solution containing copper ions and at least one additive ion selected from the group consisting of a divalent tin ion, a divalent manganese ion, a trivalent vanadium ion, a tetravalent vanadium ion, a trivalent cerium ion, a divalent iron ion and a monovalent silver ion is mixed with an alkaline solution to form copper hydroxide, and then a reducing agent is added thereto to deposit cuprous oxide particles by reduction. It is preferable that when forming copper hydroxide and depositing cuprous oxide particles by reduction, the reaction solution be stirred so that the reaction solution becomes homogeneous.

Inorganic copper compounds such as copper chloride, copper sulfate, copper nitrate, copper cyanide, copper thiocyanate, copper fluoride, copper bromide, copper iodide, copper carbonate, copper phosphate, copper fluoroborate, copper hydroxide and copper pyrophosphate, organic copper compounds such as copper acetate and copper lactate, and a hydrate thereof may be used as a copper ion source contained in the aqueous solution. These copper ion sources may be used singly or in combinations of two or more. Of these copper ion sources, copper chloride and copper sulfate are preferably used because they have high solubility in water and are inexpensive. The concentration of copper ions in the aqueous solution is preferably 0.1 mol/L to 2 mol/L from the viewpoint of reaction efficiency. When the concentration of copper ions is less than 0.1 mol/L, reaction efficiency may be reduced and the yield of cuprous oxide may be reduced. By contrast, when the concentration of copper ions is more than 2 mol/L, coagulation is likely to occur.

At least one additive ion selected from the group consisting of a divalent tin ion, a divalent manganese ion, a trivalent vanadium ion, a tetravalent vanadium ion, a trivalent cerium ion, a divalent iron ion and a monovalent silver ion, which are contained in the aqueous solution, has the effect of reducing the average primary particle size of the resulting cuprous oxide particles and improving properties of reduction to copper and sintering. Inorganic tin compounds such as tin (II) chloride, tin (II) sulfate, tin (II) oxide, tin (II) fluoride, tin (II) bromide and tin (II) iodide, organic tin compounds such as tin (II) acetate, and a hydrate thereof may be used as a divalent tin ion source. These may be used singly or in combinations of two or more. Inorganic manganese compounds such as manganese (II) sulfate, manganese (II) chloride and manganese (II) nitrate, organic manganese compounds such as manganese (II) acetate, and a hydrate thereof may be used as a divalent manganese ion source. These may be used singly or in combinations of two or more. Inorganic vanadium compounds such as vanadium (IV) oxysulfate, vanadium (IV) tetrachloride, vanadium (IV) oxychloride, vanadium (III) chloride, vanadium (III) oxide and vanadium (IV) oxide, organic vanadium compounds such as vanadium (IV) tetraacetate, and a hydrate thereof may be used as a trivalent or tetravalent vanadium ion source. These may be used singly or in combinations of two or more. Inorganic cerium compounds such as cerium (III) chloride, cerium (III) oxide, cerium (III) nitrate, cerium (III) sulfate, cerium (III) fluoride, cerium (III) bromide and cerium (III) iodide, organic cerium compounds such as cerium (III) oxalate and cerium (III) acetate, and a hydrate thereof may be used as a trivalent cerium ion source. These may be used singly or in combinations of two or more. Inorganic iron compounds such as iron (II) sulfate, iron (II) chloride, iron (II) bromide, iron (II) nitrate, iron (II) hydroxide, iron (II) oxide and iron (II) phosphate, organic iron compounds such as iron (II) acetate, iron (II) oxalate, iron (II) citrate and iron (II) lactate, and a hydrate thereof may be used as a divalent iron ion source. These may be used singly or in combinations of two or more. Inorganic silver compounds such as silver (I) chromate, silver (I) dichromate, silver (I) oxide, potassium dicyanoargentate (I), silver (I) cyanide, silver (I) bromide, silver (I) nitrate, silver (I) selenate, silver (I) tungstate, silver (I) carbonate, silver (I) thiocyanate, silver (I) telluride, silver (I) fluoride, silver (I) molybdate, silver (I) iodide, silver (I) sulfide, silver (I) sulfate, silver (I) phosphate, silver (I) diphosphate, silver (I) nitrite, silver (I) isocyanate, silver (I) chloride and silver (I) perchlorate, organic silver compounds such as silver (I) citrate, silver (I) acetate, silver (I) lactate, silver (I) formate and silver (I) benzoate, and a hydrate thereof may be used as a monovalent silver ion source. These may be used singly or in combinations of two or more. The concentration of additive ions in the aqueous solution is not particularly limited as long as the concentration allows the content of the additive element in the cuprous oxide particles finally obtained to fall within the preferred range described above. It is preferable that the concentration be 0.001 mol to 0.1 mol based on 1 mol of copper ions from the viewpoint that the additive ion is easily incorporated into cuprous oxide to form a co-deposit and the co-deposit facilitates photosintering. The average primary particle size of the cuprous oxide particles finally obtained can be controlled by changing the concentration of the additive ion. More specifically, the higher the concentration of the additive ion, the more the average primary particle size of the cuprous oxide particles can be reduced.

A usual alkaline solution prepared by dissolving alkali such as sodium hydroxide, potassium hydroxide and lithium hydroxide in water may be used as the alkaline solution. It is preferable that the concentration of alkali be 0.1 mol to 10 mol based on 1 mol of copper ions contained in the copper ion-containing aqueous solution to be mixed with the alkaline solution from the viewpoint of control of the particle size of the cuprous oxide particles finally obtained and control of reduction reaction. When the concentration is less than 0.1 mol, reduction to cuprous oxide may be insufficient and reaction efficiency may be reduced. By contrast, when the concentration is more than 10 mol, a part of cuprous oxide may be even reduced to copper.

The reaction temperature at which the copper ion-containing aqueous solution is mixed with the alkaline solution to form copper hydroxide is not particularly limited. The reaction temperature may be 10° C. to 100° C. and is preferably 30° C. to 95° C. from the viewpoint of control of the reaction. The average primary particle size of the cuprous oxide particles finally obtained can be controlled by changing the reaction temperature at this stage. More specifically, the average primary particle size of the cuprous oxide particles can be increased by raising the reaction temperature. The reaction time is not particularly limited, and may be more than 0 minute and 120 minutes or less because copper hydroxide may be formed immediately after mixing depending on the concentration of copper ions, the type and the concentration of the alkaline solution and the reaction temperature. When the reaction time is more than 120 minutes, copper oxide is gradually formed from copper hydroxide due to the action of additive ions.

Glucose, fructose, maltose, lactose, hydroxylamine sulfate, hydroxylamine nitrate, sodium sulfite, sodium hydrogen sulfite, sodium dithionite, hydrazine, hydrazine sulfate, hydrazine phosphate, hypophosphoric acid, sodium hypophosphate, sodium boronydride and the like may be used as a reducing agent. Of these reducing agents, reducing sugars such as glucose and fructose are preferred because they are inexpensive, easily available, can be easily handled and have high efficiency of reduction to cuprous oxide. The amount of the reducing agent added is preferably 0.1 mol to 10 mol based on 1 mol of copper ions from the viewpoint of control of reduction reaction from copper hydroxide to cuprous oxide. When the amount of the reducing agent added is less than 0.1 mol, the reduction reaction from copper hydroxide to cuprous oxide may be insufficient. By contrast, when the amount of the reducing agent added is more than 10 mol, excess reducing agent may reduce even a part of cuprous oxide to copper.

The reaction temperature for reduction and deposition is not particularly limited. The temperature may be 10° C. to 100° C. and is preferably 30° C. to 95° C. from the viewpoint of control of the reaction. Here, the reaction time is not particularly limited, and may be usually 5 minutes to 120 minutes. When the time of reduction and deposition is less than 5 minutes, reduction reaction from copper hydroxide to cuprous oxide may be insufficient. On the other hand, when the time of reduction and deposition is more than 120 minutes, a part of the cuprous oxide deposited may be oxidized to copper oxide.

A slurry containing cuprous oxide particles deposited is filtered and the resultant is washed with water to give a cuprous oxide cake. Methods of filtration and water washing include a method of water washing while particles are fixed with a filter press and the like, a method in which operation of decanting slurry, removing the supernatant, then adding pure water thereto, stirring the mixture, then decanting the solution again, and removing supernatant is repeated, and a method in which operation of repulping cuprous oxide particles after filtration and then filtering again is repeated. The resulting cuprous oxide particles may be subjected to a treatment for preventing oxidation if necessary. For example, the treatment for preventing oxidation is performed using an organic substance such as saccharide, polyhydric alcohol, rubber, heptonic, carboxylic acid, phenol, paraffin and mercaptan, or an inorganic substance such as silica. The resulting cuprous oxide cake is then dried in an atmosphere and at a temperature where cuprous oxide is not reduced to copper and not oxidized to copper oxide (e.g. in vacuum at 30° C. to 150° C.) to give cuprous oxide particles. The resulting cuprous oxide particles may be subjected to a treatment such as crashing and sieving if necessary.

The metal particle used in the present invention is not particularly limited as long as it has a volume resistivity at 20° C. of 1.0×10⁻³ Ω·cm or less. It is preferable that the particle is at least one member selected from the group consisting of gold (having a volume resistivity at 20° C. of 2.4×10⁻⁶ Ω·cm), silver (having a volume resistivity at 20° C. of 1.6×10⁻⁶ Ω·cm), copper (having a volume resistivity at 20° C. of 1.7×10⁻⁶ Ω·cm), zinc (having a volume resistivity at 20° C. of 5.9×10⁻⁶ Ω·cm), tin (having a volume resistivity at 20° C. of 11.4×10⁻⁶ Ω·cm), aluminum (having a volume resistivity at 20° C. of 2.75×10⁻⁶ Ω·cm), nickel (having a volume resistivity at 20° C. of 7.2×10⁻⁶ Ω·cm), cobalt (having a volume resistivity at 20° C. of 6.4×10⁻⁶ Ω·cm) and manganese (having a volume resistivity at 20° C. of 48×10⁻⁶ Ω·cm). Of these metal particles, copper particles are preferred from the viewpoint of conductivity and low cost. Furthermore, two or more of these metal particles may be used, or an alloy particle having a volume resistivity at 20° C. of 1.0×10⁻³ Ω·cm or less may also be used.

The average primary particle size of the metal particles is preferably 10 nm to 50 μm, and more preferably 50 nm to 10 μm from the viewpoint of handleability and photosintering properties. The average primary particle size of the metal particles according to the present invention means a value obtained by measuring the primary particle size of 50 particles randomly selected in an image observed by a scanning electron microscope (SEM) and arithmetically averaging the values. Furthermore, the shape of the metal particle is not particularly limited, and may be spherical, polyhedral, flaky, irregular, an agglomerated powder, or a mixture thereof.

The photosintering composition of the present invention may be used as not only a material for forming a conductive film but also a material for forming copper wiring, a copper joining material, an alternative material for copper plating, a material for rectifiers, a material for solar cells and the like. Preferably 10% by mass to 90% by mass, more preferably 20% by mass to 75% by mass of the cuprous oxide particles and the metal particles in total are contained based on the photosintering composition from the viewpoint of suppressing an increase in the viscosity and forming a sufficiently thick conductive film. When the total amount of the cuprous oxide particles and the metal particles is less than 10% by mass, a sufficiently thick coating film may not be obtained even by applying the photosintering composition to a substrate and the conductive film may not be continuous after photosintering. By contrast, when the total amount of the cuprous oxide particles and the metal particles is more than 90% by mass, the amount of solid components increases to increase the viscosity of the photosintering composition, making application to a substrate difficult in some cases. Preferably 10% by mass to 90% by mass, more preferably 25% by mass to 80% by mass of a solvent is contained based on the photosintering composition from the viewpoint of suppressing an increase in the viscosity, handleability and photosintering properties. The mass ratio between the metal particles and the cuprous oxide particles contained in the photosintering composition of the present invention is preferably 95:5 to 55:45, and more preferably 90:10 to 60:40 from the viewpoint of preventing scattering in photosintering, and photosintering properties and adhesion of conductive film.

The solvent is not particularly limited and may be inorganic or organic as long as it serves as a dispersion medium for cuprous oxide particles and metal particles. Examples of solvents include water, monohydric alcohol, polyhydric alcohols such as dihydric alcohol and trihydric alcohol, ethers and esters. Specific examples of solvents other than water include methanol, ethanol, propanol, isopropyl alcohol, isobutanol, 1,3-propanediol, 1,2,3-propanetriol (glycerol), ethylene glycol, diethylene glycol, triethylene glycol, dipropylene glycol, ethylene glycol monomethyl ether, ethylene glycol monoethyl ether, ethylene glycol monopropyl ether, diacetone alcohol, ethylene glycol monobutyl ether, propylene glycol, diethylene glycol monomethyl ether, diethylene glycol monoethyl ether, dipropylene glycol monopropyl ether, diethylene glycol monobutyl ether (butylcarbitol), tripropylene glycol, triethylene glycol monoethyl ether, terpineol, dihydroterpineol, dihydroterpinyl monoacetate, methyl ethyl ketone, cyclohexanone, ethyl lactate, propylene glycol monomethyl ether acetate, diethylene glycol monomethyl ether acetate, diethylene glycol monobutyl ether acetate, ethylene glycol monomethyl ether acetate, ethylene glycol monobutyl ether acetate, dibutyl ether, octane and toluene. These solvents may be used singly or in combinations of two or more.

Of these solvents, water is preferred from the viewpoint of handleability, drying properties of coating film and viscosity. Terpineol and dihydroterpineol are preferred from the viewpoint of dispersing components in the photosintering composition well.

The photosintering composition of the present invention may contain an additional component in addition to the cuprous oxide particle, the metal particle and the solvent. Examples of such additional components include a binder resin, a dispersant, a protective agent, a viscosity adjusting agent, an anti-settling agent, a thixotropy imparting agent, a reducing agent, an affinity agent for a substrate on which a conductive film is formed and a sintering auxiliary. It is preferable that these additional components be removed by evaporation in the step of drying or by gasification in the step of sintering. Compounds composed of carbon, hydrogen, oxygen and nitrogen are particularly preferred.

Specific examples of the binder resin include a cellulose resin and derivatives thereof, polyurethane, a polyester resin, polyvinylpyrrolidone, a poly-N-vinyl compound, a chlorinated polyolefin resin, a polyacrylic resin, an epoxy resin, an epoxy acrylate resin, a phenol resin, a melamine resin, a urea resin, an alkyd resin, polyvinyl alcohol, polyvinyl butyral, α-methyl styrene polymer, a terpene resin, a terpene phenol resin, a petroleum resin, a hydrogenated petroleum resin, a cyclopentadiene petroleum resin, a polybutadiene resin, a polyisoprene resin, a polyether resin and ethylene oxide polymer. A binder resin is usually dissolved in a solvent to be used. These binder resins may be used singly or in combinations of two or more. Resins that improve adhesion properties to a substrate, dissolve in a solvent at a high concentration, have a function of a reducing agent, and can provide a conductive film having good conductivity are preferred as the binder resin. Furthermore, since the viscosity of the composition can be adjusted by mixing a binder resin, the viscosity of the composition can be adjusted so as to be suitable for various printing applications such as inkjet printing and screen printing. Of them, ethyl cellulose, an acrylic resin and an epoxy resin are particularly preferred from the viewpoint of coating properties, adhesion properties and photosintering properties, although they have different levels of effect.

The content of the binder resin may be within the range of 10% by mass to 90% by mass in total including the solvent described above based on the photosintering composition. Preferably 0.01% by mass to 40% by mass, and more preferably 0.2% by mass to 30% by mass of binder resin is contained in the photosintering composition from the viewpoint of improving coating properties and adhesion properties. When the content of the binder resin is more than 40% by mass, the viscosity of the photosintering composition increases and a good coating film may not be formed. Furthermore, the binder resin remains in the conductive film after photosintering as a redundant resin and may cause an increase in the resistance value of the conductive film.

The method of forming a conductive film of the present invention includes a step of applying the photosintering composition described above to a substrate to form a coating film and a step of irradiating the coating film with light to reduce cuprous oxide particles in the coating film.

Materials of substrates on which a conductive film is formed are not particularly limited. Examples thereof include resin such as polyethylene terephthalate, polyimide and polyethylene naphthalate; glass such as quartz glass, soda glass and alkali-free glass; metals such as iron, copper and aluminum; semimetals such as silicon and germanium; ceramics such as alumina, zirconia, silicon nitride and silicon carbide; and paper. Since substrates are not excessively heated in the method of forming a conductive film of the present invention, the method is suitable for forming a conductive film on a resin substrate with a low heat resistance.

A suitable method may be selected as a method of applying the photosintering composition to a substrate depending on, for example, the viscosity of the photosintering composition and the average primary particle size of cuprous oxide particles and metal particles. Specific examples of methods of coating include a bar coating method, a spray coating method, a spin coating method, a dip coating method, a roll coating method, an inkjet printing method, a gravure printing method and a screen printing method. The thickness of the coating film may be appropriately determined based on the thickness of the intended conductive film, and is preferably 0.1 μm to 100 μm from the viewpoint of sintering properties and adhesion properties. When the thickness of the coating film is less than 0.1 μm, the conductive film is unlikely to be continuous due to volume contraction of cuprous oxide particles after sintering, and sufficient conductivity may not be obtained. By contrast, when the thickness of the coating film is more than 100 μm, photoirradiation energy does not reach the bottom part of the coating film and only the surface is sintered, and thus the conductive film is easily separated from the substrate.

It is preferable that the method of forming a conductive film of the present invention also include a step of drying a coating film after forming the coating film. Removal of solvent remaining in the coating film by drying makes it possible to reduce generation of defects in the conductive film in the step of reduction described later. For drying the coating film, a known dryer such as an air dryer and a warm air dryer may be used. For the condition of drying of the coating film, the coating film is dried usually at 60° C. to 120° C. for 5 minutes to 60 minutes.

To reduce cuprous oxide particles in the coating film to copper and sinter them, the coating film may be irradiated with light using a known photoirradiation apparatus. For photoirradiation, pulsed light irradiation is preferred from the viewpoint that temperature can be easily controlled. Pulsed light irradiation with a flash lamp is preferred as pulsed light irradiation, and pulsed light irradiation with a xenon (Xe) flash lamp is more preferred. Examples of apparatus which can perform such pulsed light irradiation include S-series xenon pulsed light system made by Xenon Corporation and Pulse Forge series photosintering apparatus made by Novacentrix. S-2300 by Xenon Corporation, in particular, allows a simple setting of pulsed light of voltage 1/pulse width 1 in a single pulse, and also has a function of sequentially setting voltage 2/pulse width 2 after voltage 1/pulse width 1 in a single pulse, and thus continuous pulsed light irradiation in two or more steps in different conditions are available. As described above, being capable of controlling irradiation energy for sintering, S-2300 by Xenon Corporation is suitable for sintering cuprous oxide. The number of steps is not particularly limited as long as cuprous oxide can be sintered, and a plurality of steps may be set.

The irradiation energy and the pulse width of pulsed light may be appropriately selected based on the average primary particle size of cuprous oxide particles, the type and the concentration of solvent, the thickness of coating film, the type of additives and the like so that cuprous oxide can be reduced to copper and sintered. More specifically, accumulated pulsed light irradiation energy for sintering is preferably 0.001 J/cm² to 100 J/cm², more preferably 0.01 J/cm² to 30 J/cm² from the viewpoint of sufficient sintering and reducing damage on the substrate. When the accumulated pulse irradiation energy is less than 0.001 J/cm², cuprous oxide particles may not be sufficiently sintered, while when it is more than 100 J/cm², cuprous oxide particles may be scattered and damage on the substrate may increase depending on the pulse width. The pulse width of the pulsed light is preferably 1μ second to 100 m seconds, more preferably 10μ seconds to 10 m seconds from the viewpoint of sufficient sintering and reducing damage on the substrate. When the pulse width is less than 1μ second, cuprous oxide particles may not be sufficiently sintered, while when it is more than 100 m seconds, cuprous oxide particles may be scattered and damage on the substrate may be increased depending on the irradiation energy.

The number of times of irradiation of pulsed light is not particularly limited as long as cuprous oxide can be sintered. The same irradiation pattern may be repeated a few times or various irradiation patterns may be repeated a few times. It is preferable that cuprous oxide be sintered by 5 times or less of irradiation from the viewpoint of productivity and damage on the substrate, but the number of the times is not limited thereto depending on the type of the substrate. Since coating films formed of the photosintering composition of the present invention are less likely to be scattered even by photoirradiation, sintering may be performed by single irradiation while adjusting the irradiation energy and the pulse width of the pulsed light.

Furthermore, the atmosphere in which pulsed light irradiation is performed is not particularly limited, and may be performed in any one of air atmosphere, inert gas atmosphere and reducing gas atmosphere.

### EXAMPLES

Hereinafter, the present invention will be described with reference to Examples, but the present invention is not limited to these Examples.

### <Preparation of Cuprous Oxide Particles>

25.0 g of a 48% by mass aqueous sodium hydroxide solution and 100.0 g of pure water were put in a 500 mL reaction vessel, and the temperature inside the reaction vessel was adjusted to 40° C. with stirring the content of the reaction vessel to prepare an alkaline solution.

Meanwhile, 17.3 g (0.1 mol) of copper (II) chloride dihydrate, 80.0 g of pure water and 0.45 g (0.002 mol) of tin (II) chloride dihydrate which was a divalent tin ion source were put in a 100 mL glass beaker to prepare an aqueous solution containing copper ions and divalent tin ions. The aqueous solution containing copper ions and divalent tin ions were added to the reaction vessel over about 2 minutes with maintaining the temperature in the reaction vessel at 40° C., and then the mixture was stirred for 10 minutes to deposit copper hydroxide.

10.0 g of glucose and 15.0 g of pure water were put in a 100 mL glass beaker to prepare a reducing agent solution. The reducing agent solution was added to the reaction vessel over about 30 seconds, and then the temperature in the reaction vessel was increased to 50° C. and the temperature was maintained for 15 minutes. Then, the stirring in the reaction vessel was stopped, and the slurry was filtered and washed to prepare a cake. The cake was vacuum dried at 80° C. for 3 hours to give cuprous oxide particles.

The average primary particle size of the resulting cuprous oxide particles was determined to be 0.1 μm from an image observed by an electron micrograph (SEM) of the cuprous oxide particles. Furthermore, the content of tin in the cuprous oxide particles was 570 ppm.

### Example 1

A photosintering composition was prepared and a conductive film was formed using the cuprous oxide particles obtained above.

More specifically, the cuprous oxide particles, metal particles, a binder resin and a solvent were kneaded at the mixing ratio shown in Table 1 using a kneader at atmospheric pressure for 30 minutes at 1,000 rpm to prepare a paste of a photosintering composition. The photosintering composition was applied to a polyimide substrate (Kapton (registered trademark) 500H made by DuPont-Toray Co., Ltd.) by screen printing in a 1 mm×20 mm rectangular pattern to form a coating film having a thickness of 4 μm. The coating film was dried in air atmosphere at 80° C. for 10 minutes. The coating film formed on the polyimide substrate was irradiated with 1 pulse of pulsed light using a xenon pulsed light system (S-2300 made by Xenon Corporation) (voltage: 2,700 V, pulse width: 2,500 microseconds) to form a conductive film.

The volume resistivity of the conductive film at room temperature was measured by using a low resistivity meter (Loresta (registered trademark)-GPMCP-T600 made by Mitsubishi Chemical Analytech Co., Ltd.). The conductive film formed was visually observed, and cases in which a uniform conductive film was formed without scattering of the coating film were determined as having “excellent” uniformity, and cases in which scattering of the coating film was observed were determined as having “poor” uniformity. Furthermore, a piece of tape was stuck to the conductive film formed and then was peeled off, and cases in which the conductive film did not adhere on the adhesive side of the tape and the conductive film formed on the polyimide substrate remained intact were determined as having “excellent” adhesion, and cases in which the conductive film adhered on the adhesive side of the tape were determined as having “poor” adhesion. The results are shown in Table 2.

### Example 2

A conductive film was formed in the same manner as in Example 1 except for changing the mixing ratio of the photosintering composition as shown in Table 1. The results of evaluation of the conductive film are shown in Table 2.

### Example 3

A conductive film was formed in the same manner as in Example 1 except for changing the mixing ratio of the photosintering composition as shown in Table 1. The results of evaluation of the conductive film are shown in Table 2.

### Example 4

A conductive film was formed in the same manner as in Example 1 except for changing the mixing ratio of the photosintering composition as shown in Table 1. The results of evaluation of the conductive film are shown in Table 2.

### Example 5

Cuprous oxide particles were prepared using 0.745 g (0.002 mol) of cerium (III) chloride heptahydrate instead of 0.45 g (0.002 mol) of tin (II) chloride dihydrate in the preparation of tin-containing cuprous oxide particles described above. The average primary particle size of the cuprous oxide particles was 270 nm and the content of cerium was 21,000 ppm. A conductive film was formed in the same manner as in Example 1 except for using the cerium-containing cuprous oxide particles instead of the tin-containing cuprous oxide particles. The results of evaluation of the conductive film are shown in Table 2.

### Example 6

Cuprous oxide particles were prepared using 0.695 g (0.0025 mol) of iron (II) sulfate heptahydrate instead of 0.45 g (0.002 mol) of tin (II) chloride dihydrate in the preparation of tin-containing cuprous oxide particles described above. The average primary particle size of the cuprous oxide particles was 100 nm and the content of iron was 1,380 ppm. A conductive film was formed in the same manner as in Example 1 except for using the iron-containing cuprous oxide particles instead of the tin-containing cuprous oxide particles. The results of evaluation of the conductive film are shown in Table 2.

### Comparative Example 1

A conductive film was formed in the same manner as in Example 1 except for changing the mixing ratio of the photosintering composition as shown in Table 1. The results of evaluation of the conductive film are shown in Table 2.

### Comparative Example 2

While a conductive film was attempted to be formed in the same manner as in Example 1 except for changing the mixing ratio of the photosintering composition as shown in Table 1, scattering of coating film occurred.

TABLE 1

| | | | | | | | Comparative | Comparative |
|---|---|---|---|---|---|---|---|---|
| | Example 1 | Example 2 | Example 3 | Example 4 | Example 5 | Example 6 | Example 1 | Example 2 |
| Cuprous oxide | 19.5 | 7.5 | 14.0 | 26.0 | 19.5 | 19.5 | — | 50.0 |
| particle | | | | | | | | |
| (% by mass) | | | | | | | | |
| Metal particle | 45.5 | 67.5 | 56.0 | 39.0 | 45.5 | 45.5 | 75.0 | — |
| (% by mass) | | | | | | | | |
| Binder resin | 1.3 | 1.5 | 1.4 | 1.3 | 1.3 | 1.3 | 1.5 | 1.0 |
| (% by mass) | | | | | | | | |
| Solvent | 33.7 | 23.5 | 28.6 | 33.7 | 33.7 | 33.7 | 23.5 | 49.0 |
| (% by mass) | | | | | | | | |
| Content of Cuprous | 65.0 | 75.0 | 70.0 | 65.0 | 65.0 | 65.0 | 75.0 | 50.0 |
| oxide particle + | | | | | | | | |
| metal particle | | | | | | | | |
| (% by mass) | | | | | | | | |
| Mass ratio of metal | 70:30 | 90:10 | 80:20 | 60:40 | 70:30 | 70:30 | 100:0 | 0:100 |
| particle:cuprous | | | | | | | | |
| oxide particle | | | | | | | | |

Details of the components in Table 1 are as follows.

Metal particle: copper particle (1100YP made by MITSUI MINING & SMELTING CO., LTD., D50=1.2 μm)

Binder resin: acrylic resin (OLYCOX KC1100 made by Kyoeisha Chemical Co., Ltd.)

Solvent: Mixture of α-, β-, and γ-terpineol isomers

TABLE 2

| | Volume resistivity | | |
|---|---|---|---|
| | [Ω · cm] | Uniformity | Adhesion |
| Example 1 | 1.8 × 10⁻⁵ | Good | Good |
| Example 2 | 9.8 × 10⁻⁵ | Good | Good |
| Example 3 | 7.3 × 10⁻⁵ | Good | Good |
| Example 4 | 2.4 × 10⁻⁵ | Good | Good |
| Example 5 | 7.6 × 10⁻⁵ | Good | Good |
| Example 6 | 6.4 × 10⁻⁵ | Good | Good |
| Comparative | 5.3 × 10⁻⁵ | Good | Poor |
| Example 1 | | | |
| Comparative | Cannot be | Scattered | Cannot be |
| Example 2 | measured because | | measured because |
| | of scattering | | of scattering |

As is evident from the results of Table 2, the conductive films formed from the photosintering composition of Examples 1 to 6 had low volume resistivity, were uniform and had excellent adhesion to the substrate. By contrast, although the conductive film formed from the photosintering composition of Comparative Example 1 had low volume resistivity, it had low adhesion to the substrate. Furthermore, in the case of the photosintering composition of Comparative Example 2, scattering of coating film occurred in the same condition of photoirradiation as in Example 1; thus, pulse irradiation was performed with 1 pulse of pulsed light while changing the pulse width to 2,000 microseconds, and the result was that sintering did not progress well.

The present international application claims priority to Japanese Patent Application No. 2018-094610 filed May 16, 2018 the contents of which is incorporated herein by reference.

1. A photosintering composition comprising a cuprous oxide particle comprising at least one additive element selected from the group consisting of tin, manganese, vanadium, cerium, iron and silver, a metal particle having a volume resistivity at 20° C. of 1.0×10⁻³ Ω·cm or less and a solvent.

2. The photosintering composition according to claim 1, wherein the metal particle is at least one metal particle selected from the group consisting of gold, silver, copper, zinc, tin, aluminum, nickel, cobalt and manganese.

3. The photosintering composition according to claim 1, wherein the additive element is tin and the content is 1 ppm to 30,000 ppm.

4. The photosintering composition according to claim 1, further comprising a binder resin.

5. The photosintering composition according to claim 1, comprising 10% by mass to 90% by mass of the cuprous oxide particles and the metal particles in total and 10% by mass to 90% by mass of the solvent.

6. The photosintering composition according to claim 4, comprising 10% by mass to 90% by mass of the cuprous oxide particles and the metal particles in total and 10% by mass to 90% by mass of the solvent and the binder resin in total.

7. A method of forming a conductive film, comprising:
a step of applying the photosintering composition according to claim 1 to a substrate to form a coating film; and
a step of irradiating the coating film with light to reduce cuprous oxide particles in the coating film.
